(19) United States
(12) Patent Application Publication
(10) Pub. No.: US 2012/0100830 A1
(43) Pub. Date: Apr. 26, 2012

(54) ANONYMOUS PARTY VOICE CALL PROCESSING

(75) Inventors: Shawn Alan Barber, Chesterfield, VA (US); Hugh Carr, County Wicklow (IE); Wijbrans Klaas, Rijen (NL)

(73) Assignee: MARKPORT LIMITED, Dublin (IE)

(21) Appl. No.: 13/379,165

(22) PCT Filed: Jun. 24, 2010
(86) PCT No.: PCT/IE2010/000040

§ 371 Date: Dec. 19, 2011

Related U.S. Application Data
(60) Provisional application No. 61/213,653, filed on Jun. 30, 2009.

(51) Int. Cl. H04W 12/02

(52) U.S. Cl. 455/410

(57) ABSTRACT

A voice processing system in a communication network performs an operation in relation to a call from an anonymous calling party to a called party in a home network associated with the system. The operation uses the identity of the anonymous calling party without revealing the identity to the called party. The operations may include allowing the called party to return a call to the anonymous calling party or to send a message to the anonymous calling party, or performing a task in response to future calls or messages from the anonymous calling party such as filtering, blocking, or diverting or requesting authorization for the calling party to call the anonymous called party on demand, hi one aspect, the system automatically generates a dummy number for the anonymous calling party and uses the dummy number to guarantee anonymity by including said dummy number in a notification message or an out-dial notification. The notification may be a missed call notification or an anonymous call notification to the called party, allowing the called party to instruct or perform an operation in relation to the anonymous call while guaranteeing anonymity A voice processing system in a communication network performs an operation in relation to a call from an anonymous calling party to a called party in a home network associated with the system. The operation uses the identity of the anonymous calling party without revealing the identity to the called party. The operations may include allowing the called party to return a call to the anonymous calling party or to send a message to the anonymous calling party, or performing a task in response to future calls or messages from the anonymous calling party such as filtering, blocking, or diverting or requesting authorization for the calling party to call the anonymous called party on demand, hi one aspect, the system automatically generates a dummy number for the anonymous calling party and uses the dummy number to guarantee anonymity by including said dummy number in a notification message or an out-dial notification. The notification may be a missed call notification or an anonymous call notification to the called party, allowing the called party to instruct or perform an operation in relation to the anonymous call while guaranteeing anonymity.

### INTRODUCTION

The invention relates to a system for processing voice calls.

A common case in voice communication is that someone makes a call, is not able to reach the other party and then disconnects without leaving a voice mail. If the caller allows visibility of his phone number, the called party often will receive a ‘missed call alert’ or ‘missed call notification’ as a message that contains the details of the initiator of the call. The called party, then in his own time, can decide to call back the initiator and still make contact. However, in many cases the calling party does not wish to leave his phone number and therefore switches on CLIR. The missed call notification will generally then only tell the called party that someone of which the address was not known made a call, thus making it impossible to return the call. As a result, communication will not take place even though the communication was apparently desired by the caller.

In addition, another common case is where someone is called by an anonymous caller. This results in the dilemma of whether to answer the call: for example the caller may be making an unsolicited call such as a marketing call from a call centre. However it could alternatively be an important call.

US2009/0131022 (RIM) describes apparatus and methods for anonymous messaging, in which the originator network replaces the address of a message originator, and a temporary identifier may be provided. EP1853029 (RIM) describes use of a globally routable identifier under the Session Initiated Protocol (SIP) to maintain anonymity of a user agent.

The invention is directed towards providing more versatile call processing where the caller party wishes to remain anonymous. Another objective is to particularly provide improved call processing versatility for the voice call recipient network.

### SUMMARY OF THE INVENTION

According to the invention, there is provided a voice call processing system for a communications network, the system comprising at least one call server, wherein the system is adapted to perform an operation in response to a call from an anonymous calling party to a called party, said operation using the identity of the anonymous calling party without revealing said identity to the called party.

In one embodiment, the system is adapted to perform said operations as a recipient network function.

In one embodiment, the system is adapted to allow the called party to return a call or to send a message to the anonymous calling party.

In one embodiment, the system is adapted to perform a task in response to future calls or messages from the anonymous calling party, including filtering, blocking, or diverting said future call or message.

In another embodiment, the system is adapted to request authorization for the calling party to call the called party on demand.

In one embodiment, the system is adapted to automatically generate a dummy number for the anonymous calling party and to use the dummy number to guarantee anonymity by including said dummy number in a notification message or an out-dial notification.

In one embodiment, said notification is a missed call notification or an anonymous call notification to the called party, allowing the called party to instruct or perform an operation in response to the anonymous call while guaranteeing anonymity.

In another embodiment, the system is adapted to maintain in a table an association between the dummy number and an actual phone number of the calling party.

In one embodiment, the system is adapted to send a notification message to the anonymous calling party as part of an operation.

In one embodiment, the system is adapted to manage call screening of anonymous calls for subscribers.

In one embodiment, said call screening includes diverting future calls from an anonymous calling party and/or generating anonymous call reports for the called party.

In a further embodiment, the system is adapted to receive from a subscriber a request for an operation.

In one embodiment, the system is adapted to receive from a subscriber a request for an anonymous call screening operation.

In one embodiment, the system is adapted to receive and parse a request in the form of a message with a keyword command such as ‘block always’, ‘block anonymous’, ‘divert always’ or ‘divert anonymous’.

In one embodiment, the system is adapted to provide to a called party, under conditions, the actual number of an anonymous calling party from internal records

In one embodiment, the system is adapted to generate a notification message for the called party whenever an anonymous party has called, irrespective of whether the call has been missed.

In one embodiment, the system is adapted to apply at least one condition on an option for the called party to return the call. A condition may be a time limit, and/or a limit on the number of return calls allowed.

In a further embodiment, the system is adapted to update a database according to operations performed, including deleting a database record if an option to perform an operation has terminated.

In one embodiment, the system is adapted to process notification messages in any of a range of protocols including SMS, SIP messaging, and MMS.

In one embodiment, the system comprises an interactive voice response system adapted to generate a message requesting approval for an operation. Preferably, the interactive voice response system is adapted to generate a prompt that a call cannot be completed and that the calling party can select whether he wishes his anonymous call to be returned or not, and if the answer is negative, it is logged that the calling party does not allow dial back or message return.

In one embodiment, a combination of called party number and a dummy number form at least part of a unique reference for a database record.

In one embodiment, the system is adapted to terminate use of a dummy number, such as by deleting it from a database.

In one embodiment, the system is adapted to perform said deletion in response to a condition. Preferably, a condition is return of a particular number of calls to the anonymous caller and/or expiry of an ageing period.

In one embodiment, the system is adapted to pro-actively request permission from the called party before performing an operation which it proposes.

In one embodiment, the system is adapted to provide information to the called party in response to a pull request, instead of or in addition to providing such information in a notification.

In another aspect, the invention provides a method of operation of a voice processing system in a communication network, the method comprising the system performing an operation in response to a call from an anonymous calling party to a called party in a recipient network associated with the system, said operation using the identity of the anonymous calling party without revealing said identity to the called party.

In one embodiment, the method comprises the step of allowing the called party to return a call or to send a message to the anonymous calling party.

In one embodiment, the method comprises performing a task in response to future calls or messages from the anonymous calling party, said tack being filtering, and/or blocking, and/or diverting said future call or message.

In one embodiment, the system requests authorization for the calling party to call the called party on demand.

In one embodiment, the system automatically generates a dummy number for the anonymous calling party and uses the dummy number to guarantee anonymity by including said dummy number in a notification message or an out-dial notification.

In one embodiment, said notification is a missed call notification or an anonymous call notification to the called party, allowing the called party to instruct or perform an operation in response to the anonymous call while guaranteeing anonymity.

In one embodiment, the system sends a notification message to the anonymous calling party as part of an operation.

In a further embodiment, the system manages call screening of anonymous calls for subscribers, including diverting future calls from an anonymous calling party and/or generating anonymous call reports for the called party.

In one embodiment, the system receives from a subscriber a request for an anonymous call screening operation.

In one embodiment, the request is in the form of a message with a keyword command such as ‘block always’, ‘block anonymous’, ‘divert always’ or ‘divert anonymous’.

In one embodiment, the system provides to a called party, under conditions, the actual number of an anonymous calling party from internal records

In one embodiment, the system generates a notification message for the called party whenever an anonymous party has called, irrespective of whether the call has been missed.

In one embodiment, the system applies at least one condition on an option for the called party to return the call, said condition being a time limit, and/or a limit on the number of return calls allowed.

In one embodiment, the system pro-actively requests permission from the called party before performing an operation which it proposes.

In another aspect, the invention provides a computer program product comprising a computer readable medium having a computer readable program code adapted to be executed to implement any method as defined above.

### DETAILED DESCRIPTION OF THE INVENTION

The invention will be more clearly understood from the following description of some embodiments thereof, given by way of example only with reference to the accompanying drawings in which:

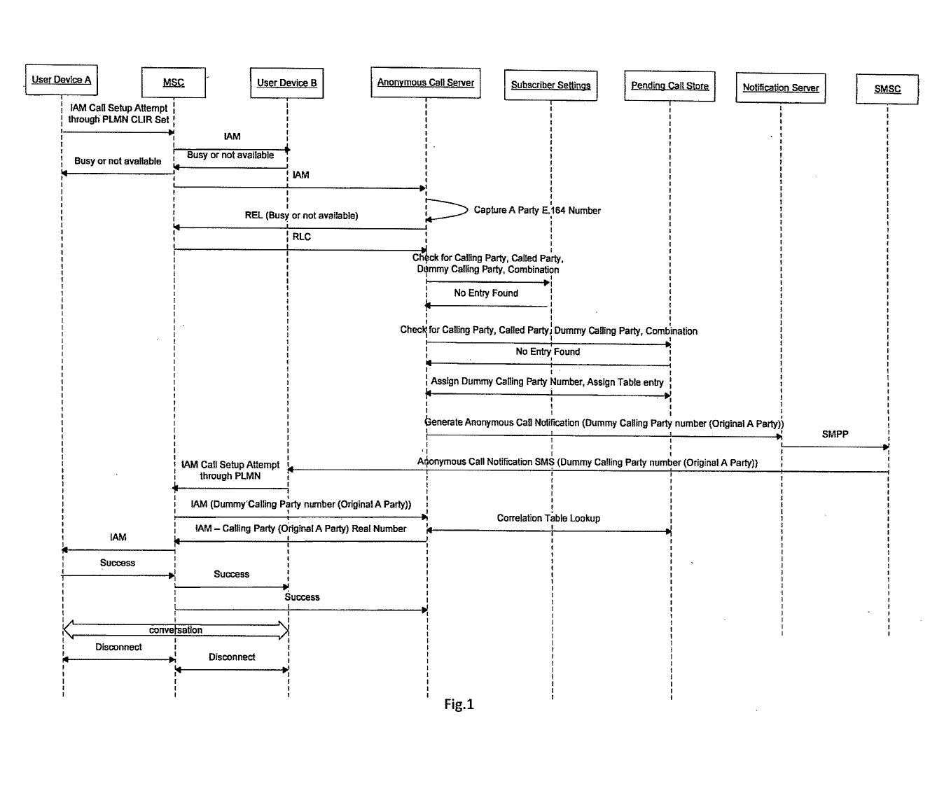

FIGS. 1 to 3 are transaction flows for processing of missed call and/or anonymous call notifications;

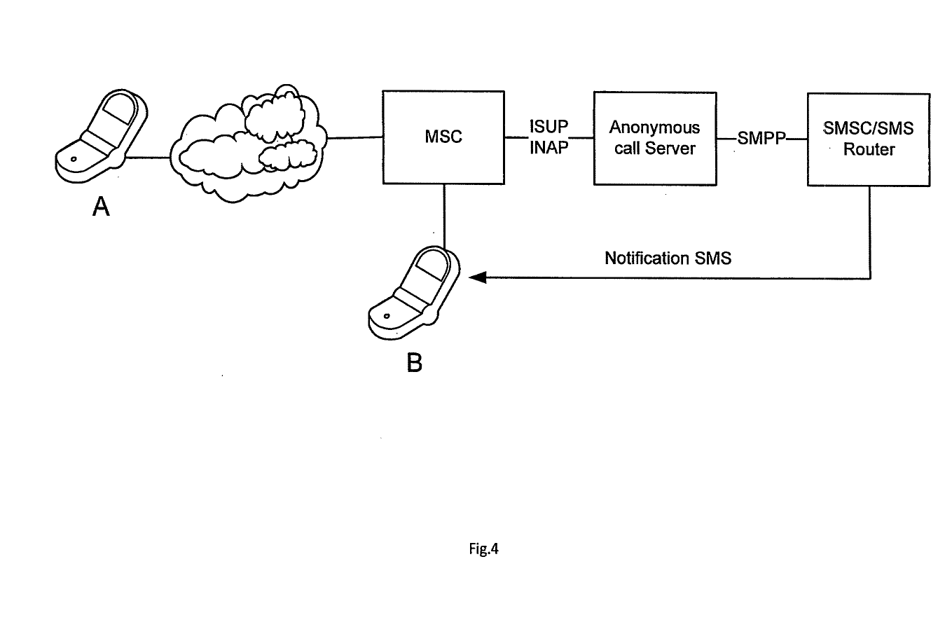

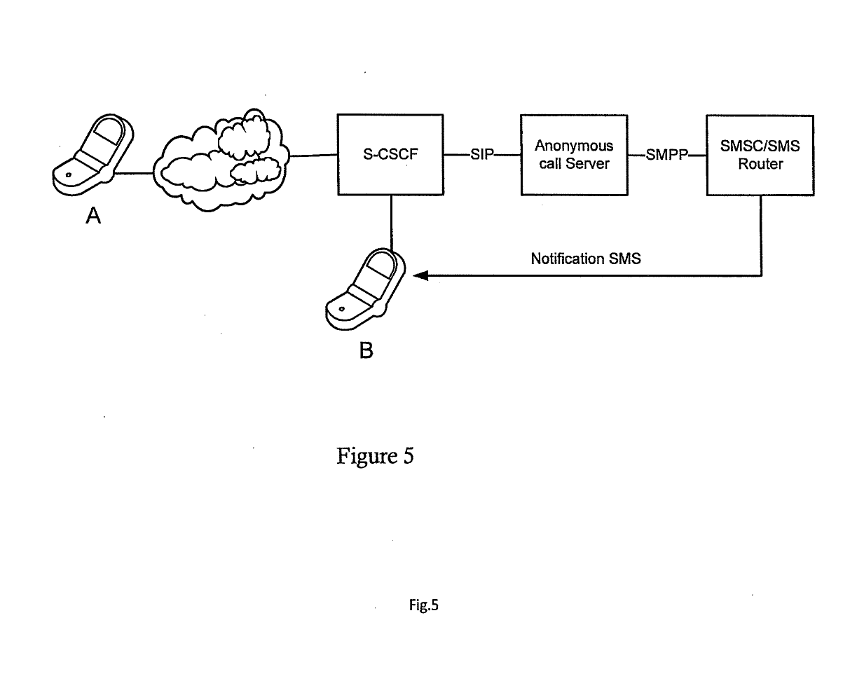

FIGS. 4 and 5 show architectural context of a system of the invention;

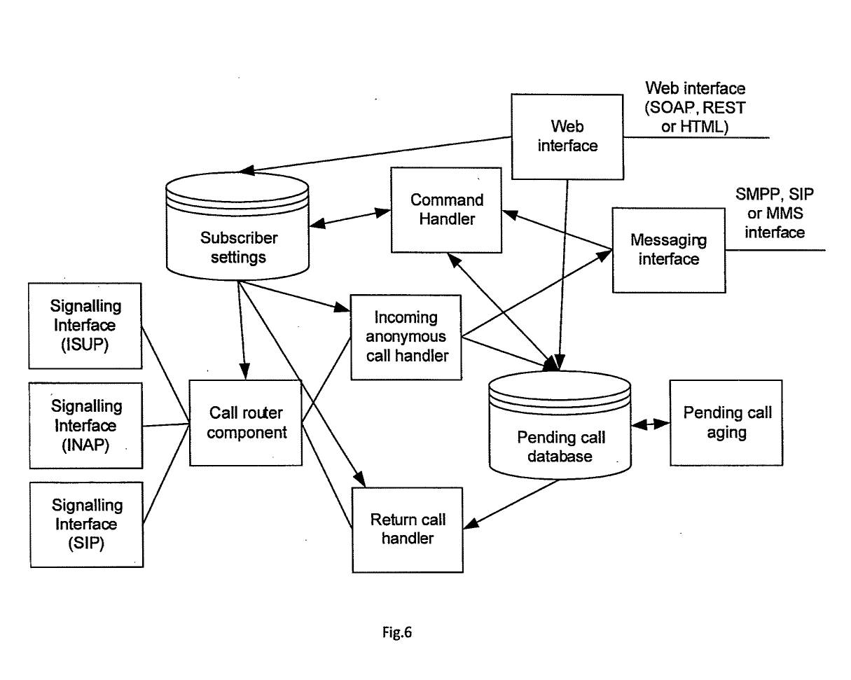

FIG. 6 is a diagram illustrating architecture of an anonymous call server of the system; and

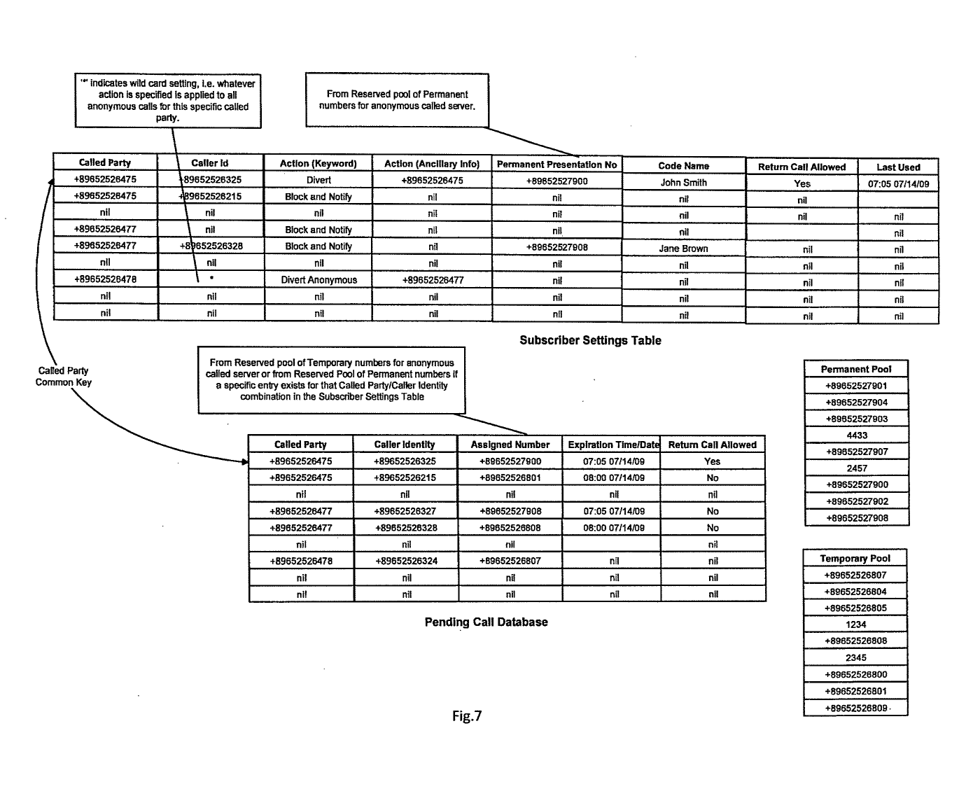

FIG. 7 is a diagram illustrating number mapping in the system.

### GLOSSARY OF TERMS AND THEIR DEFINITIONS

| | |
|---|---|
| Missed Call | Message sent to a called party if an attempt to call the |
| Notification | called party has failed. |
| Anonymous Call | The (SMS) message sent to a called party if an |
| Notification | anonymous party called (regardless of whether the |
| | call succeeded or failed). |
| Missed Call | A call which is not answered, irrespective of the reason. |
| Calling Party | The A party who initiates the initial (anonymous) call. |
| Called Party | The B party of the initial (anonymous) call. |

A system extends missed call notifications in such a way that it will be possible to return the call to an anonymous caller for which a missed call notification was generated, without the anonymous caller being required to disclose his phone number. Also, the invention can be used to always generate a notification message whenever an anonymous party has called.

The invention is implemented by an “anonymous call server” and a “notification server”. In hardware terms these comprise separate devices consisting of memory, a controller and low-speed or high-speed SS7 signalling links, and an Ethernet interface for connectivity towards an SMSC using UCP or SMPP and are linked into the mobile network towards the MSC (the mobile switching centre) intercepting the ISUP IAM and ANM messages and to an SMSC using UCP or SMPP.

In addition, the system can return a message to the anonymous caller for which the missed call notification was generated. More generally, the system allows a wide variety of operations to be performed in response to a call from an anonymous caller, whether the call was missed or not. Another example of such an operation is setting of blocking or filtering of subsequent calls from the particular anonymous caller.

The system automatically assigns a dummy number to an anonymous caller, and uses this dummy number in communications with the called party. The called party can respond using the dummy number. The system recognizes the dummy number and sets a desired setting or attribute to perform correlation of the anonymous caller and the called party. Because the system “knows” the real number of the anonymous caller it can perform any of a wide variety of operations requested by the called party. These operations include returning a call or sending a message to the anonymous caller, or setting a filter or block for future calls from the anonymous caller. However, the invention is not limited to these examples. Also, the system may retain the dummy number for only a short duration, deleting it in response to a condition such as a time-out or in response to an operation being performed. The latter may be deleted after only one return call, or a set number, more than one for example.

The following describes some embodiments. The dummy number is given different names in different contexts. For example, where it is persistent for future operations it is called a “persistent” number. Because it is the number viewed by the called party it is alternatively referred to as a “presentation” number in some parts of the description. The word “temporary” is used where it is to be held only temporarily by the system, such as sufficiently to make a return call for example.

The term “dummy number” should be interpreted to mean a number in conventional telephony or a code such as an alphanumeric code. If it is a telephony number the called party can request an operation by accessing the system using the dummy number itself, or if it is not the called party could access the system using a standard number accompanied by the code.

Scenario 1 (Refer to FIG. 1, and FIG. 7 for Details on ACS Internal Tables).
1. Person A tries to call person B anonymously. However, person B is not able to pick up his phone (e.g., in a meeting), out of reach, busy in another call or does not want to accept an anonymous call.
2. The system of the invention accepts the call or ‘snoops’ the dialled number in the call to generate the missed call notification (like an existing ‘missed call notification’ system would). As the message is received using the IN protocol or the ISUP protocol, the actual caller identity is known together with the CUR indicator.
3. If the CUR indicator is set, the anonymous call server (having checked if the called party is subscribed to this service, not shown in FIG. 1) checks if this called party has an entry in one or more lookup tables and if not stores the caller identity in a lookup table and assigns a dummy number to it (thus preserving anonymity) for later presentation to the Called Party.
   In more detail (not all shown in FIG. 1, refer also to FIG. 7) the anonymous call server first looks up an internal table, the ‘subscriber settings table’ for the combination of the ‘called party’ and ‘calling party’ (i.e. caller ID). If that combination exists, and assuming there is no rule defined that prevents the call from being forwarded to the calling party then the dummy number for presenting to the called party is taken from the ‘Permanent Presentation No’ field (if that field exists).
   If that combination of ‘called party’ and ‘calling party’ does not exist in the subscriber settings table (or the ‘Permanent Presentation No’ field is not set), the anonymous call server looks up its ‘pending call database’ for that combination. If found, the anonymous call server sets the dummy number from the ‘Assigned Number’ field. If that combination of ‘called party’ and ‘calling party’ is not found in the ‘pending call database’ the anonymous call server sets the dummy number to the first entry encountered in the ‘temporary pool’ (of dummy numbers) which does not appear in the ‘pending call database’ for that subscriber and inserts an entry into the ‘pending call database’ for that called party/calling party/dummy number (Assigned Number) combination.
4. The system then generates a ‘missed call notification’ message with the following contents:
   The ‘identity’ of the caller is depicted as ‘anonymous’.
   The allocated dummy phone number is shown in the message as the number to be called to contact this caller.
   The notification thus could be like:
      “You missed a call from an anonymous caller at 07:05 on Jul. 13, 2009. To return this call, please dial +89 6 5252 6801. You can also return a text message to the anonymous caller by replying to this message.”
5. Optionally, if expiration of the dummy numbers is configured, the message can contain an indication of the expiration date/time as well:
   “You missed a call from an anonymous caller at 08:00 on Jul. 13, 2009. To return this call, please dial +89 6 5252 6801 before 08:00 Jul. 14, 2009. You can also return a text message to the anonymous caller by replying to this message.”
6. If the called party wishes to respond by returning the call, he dials +89652526801
7. The call to +89652526801 is forwarded to the system, which looks up the table associated with this access number, searches for the caller id of the originator in the table and determines the party to forward the call to anonymously.
   In more detail (note in FIG. 1 only interaction with the ‘pending call database’ is shown for this transaction, refer also to FIG. 7) the anonymous call server first looks up an internal table, the ‘subscriber settings table’ for the combination of the ‘called party’ and dummy ‘calling party’ (i.e. ‘Permanent Presentation No’ in this case). If that combination exists, the Original A-Party (real B-Party number for this call) is taken from the Caller ID (original calling party) field of that record and a call attempt is made to that number.
   If that combination of ‘called party’ and ‘calling party’ does not exist in the subscriber settings table (or the ‘Permanent Presentation No’ field is not set), the anonymous call server looks up it's ‘pending call database’ for that combination. If found, the Original A-Party (real B-Party number for this call) is taken from the Caller Identity (original calling party) field of that record and a call attempt is made to that number.
   All of above assumes there is no rule that prevents the call from being forwarded to the calling party, i.e. that the calling party has not given consent for calls to be returned (if in a jurisdiction where anonymous calling party consent is required, if such jurisdictions exist). Refer to Scenario 5 below and command Request ‘Return call allowed’ for further detail on how the invention handles this further.
8. The system forwards the call to the original caller, so that the original called party can be connected to the original caller.

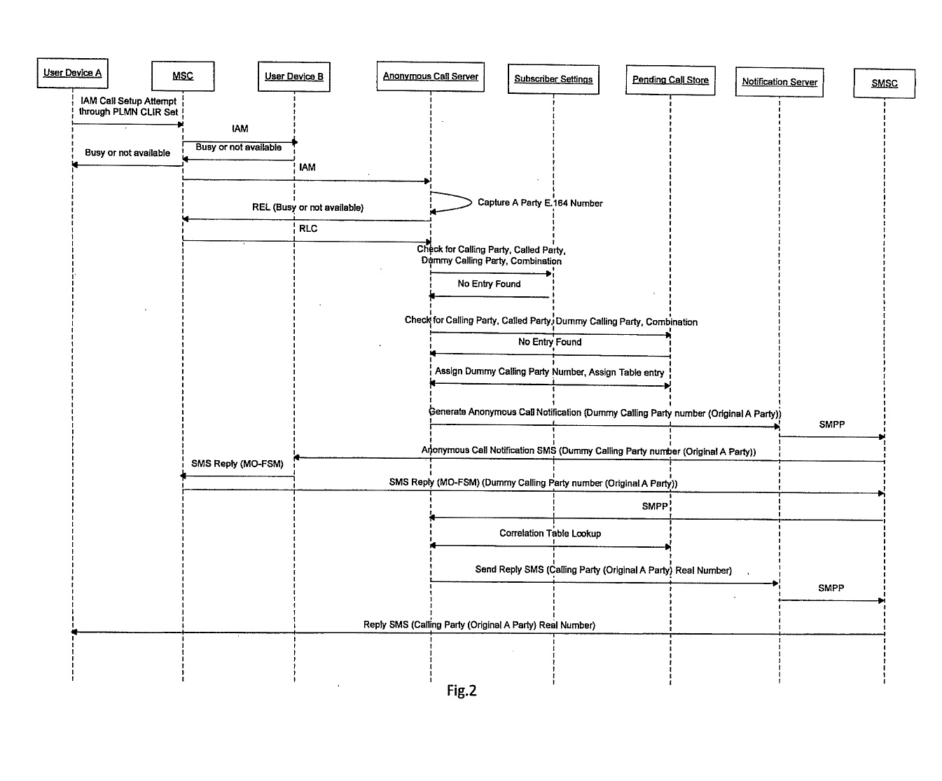

Scenario 2 (Refer to FIG. 2 and FIG. 7 for Details on ACS Internal Tables).

In addition, the system provides the capability to send a text message back to the original caller (without disclosing the identity of the original caller), thus after step 5 or optionally step 6 in scenario 1, the following steps are carried out:
1. If the called party wishes to respond with a text message, he selects to reply to the SMS message on the phone.
2. The handset will send a reply SMS to the SMSC using an MO-FSM operation with the SMS B-party set to the dummy number supplied in the ‘missed call’ notification message.
   3. The SMSC accepts the MO-FSM operation and sends it always to the anonymous call server using a normal Large Account connection for each number in the number pool that is assigned to the anonymous call server (alternatively the Large Account connection can service a range of such numbers).
4. The anonymous call server first looks up the ‘subscriber settings table’ for the combination where the SMS A-party is the ‘called party’ and the SMS B-party is the ‘Permanent Presentation No’. If that combination exists, the address to forward the message to is the ‘Caller Id’ i.e. the calling party in that record. If that combination does not exist in the subscriber settings table, the anonymous call server looks up the ‘pending call database’ for the combination where the SMS A-party is the ‘called party’ and the SMS B-party is the ‘Assigned Number’. The address to forward the message to then is the ‘Calling Party’ in that record.
   In the flow, only the interaction with the ‘pending call database’ is shown.
5. The system forwards the SMS to a normal service centre using the SMPP or UCP interface on behalf of the party sending a text message in return.
6. The normal service centre delivers the text message to the original caller.

All of above assumes there is no rule that prevents an SMS from being forwarded to the anonymous calling party, i.e. that the calling party has not given consent for such (if in a jurisdiction where anonymous calling party consent is required, if such jurisdictions exist).

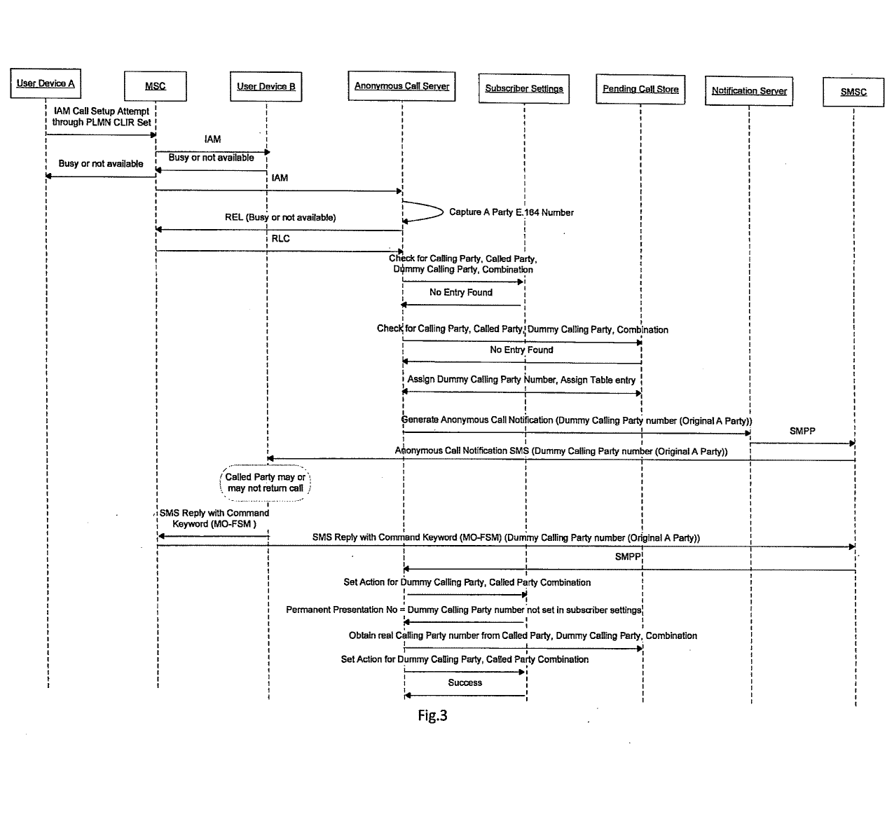

Scenario 3 (Refer to FIG. 3 and FIG. 7 for Details on ACS Internal Tables).

The system can help support called parties with specific actions such as in the screening of anonymous calls. In the case of a call with the CUR set, the handset will show ‘Private’ or ‘Anonymous’, or ‘Address unknown’, so it is difficult to decide whether to pick up the call. Because the calling party is not known to the called party, the called party is also not able to add that number to his call screening list. In the invention, this is enabled in multiple ways:
1. The called party (before or after answering the call) replies to the notification message, for example for call screening specific actions with the keyword ‘block always’, ‘block anonymous’, ‘divert always’ or ‘divert anonymous’.
2. The handset will send a reply SMS to the SMSC using an MO-FSM operation.
3. The service center accepts the MO-FSM operation and sends it via its UCP/SMPP connection to the anonymous call server. The SMSC accepts the MO-FSM operation and sends it always to the anonymous call server using a normal Large Account connection for each number in the number in the number pool that is assigned to the anonymous call server (alternatively the Large Account connection can service a range of such numbers).
4. The anonymous call server accepts the SMS message and looks up the table for the specific sender of the SMS message (the ‘called party’). In this table, it searches for the recipient address of the message and determines the entry containing the address of the original calling party.
5. The anonymous call server accepts the SMS message and first looks up the ‘subscriber settings table’ for the combination where the SMS A-party is the ‘called party’ and the SMS B-party is the ‘Permanent Presentation No’. If that combination exists, and dependent on the keyword provided, the system parses the message for keywords and, if found, sets the Action field to the keyword(s) command.
6. If that ‘called party’ and ‘dummy calling party’ combination does not exist in the subscriber settings table, the anonymous call server looks up the ‘pending call database’ for the combination where the SMS A-party is the ‘called party’ and the SMS B-party is the ‘Assigned Number’ and returns the real calling party number. At this stage the previous step 6 is repeated with the real calling party being added to the appropriate record in the ‘subscriber settings table’ if it does not already exist.
7. Thus, subsequent calls to the called party from the calling party result in execution of a function (not shown in FIG. 3) such as one of the below (which are examples of call screening functions):
   a. Blocked always. No call of this caller with or without CLIR set will ever reach the called party again.
   b. Blocked anonymous. No call of this caller with CLIR set will ever reach the called party again.
   c. Divert always. Calls of this caller with or without CLIR set will be diverted to the voice mail of the called party.
   d. Divert anonymous. Calls of this caller with CLIR set will be diverted to the voice mail of the called party.
   Other functions which can be requested via keywords include:
   e. Request ‘Permanent Presentation number’ for this calling party.
   f. Request ‘Return call allowed’ for this calling party, can be a request of a permanent nature (i.e. associated with record in ‘subscriber settings table’) or a request which has an expiration time/date against it (i.e. associated with record in ‘pending call database’). See Scenario 5 below for further detail.
   g. Assign a ‘Code Name’ for this calling party (this can be requested subsequent to a ‘Permanent Presentation number’ being requested or combined with the Request ‘Permanent Presentation number’).
   h. Change or remove the ‘Code Name’ for a specific presentation number.
   i. Remove a ‘Permanent Presentation number’ assignment.
   j. Request an overview of assigned ‘Permanent Presentation number’ assignments.
   k. Change the action with a specific ‘Permanent Presentation number’.
   l. Remove the action of a specific ‘Permanent Presentation number’.

Thus for example in the case of Blocked Always, when the calling party makes a subsequent call, the resultant IAM message to the ACS results in the ACS checking against its internal tables (i.e. subscriber settings table) and then responding to the IAM with an error code, or in the case of Divert Always the call (IAM) being redirected for example to a voicemail system.

Scenario 4 (Refer to FIG. 7 for Details on ACS Internal Tables Interaction).

In addition, the invention may also be used to notify all anonymous calls via an SMS, ensuring that at least after the anonymous call has been picked up appropriate action can be taken for the future:
1. Person A tries to call person B and successfully connects to person B.
2. The system of the invention accepts the call or ‘snoops’ the dialled number in the call to generate the anonymous call notification (like an existing ‘missed call notification’ system would). As the message is received using the IN protocol or the ISUP protocol, the actual caller identity is known together with the CLIR indicator.
3. If the CLIR indicator is set, the anonymous call server checks if this called party has an entry in one or more lookup tables and if not stores the caller identity in a lookup table and assigns a dummy number to it (thus preserving anonymity) for later presentation to the called party.
4. In more detail the anonymous call server first looks up an internal table, the ‘subscriber settings table’ for the combination of the ‘called party’ and ‘calling party’ (i.e. caller ID). If that combination exists, and assuming there is no rule defined that prevents the call from being forwarded to the calling party then the dummy number for presenting to the called party is taken from the ‘Permanent Presentation No’ field (if that field exists).
   If that combination of ‘called party’ and ‘calling party’ does not exist in the subscriber settings table (or the ‘Permanent Presentation No’ field is not set), the anonymous call server looks up it's ‘pending call database’ for that combination. If found, the anonymous call server sets the dummy number from the ‘Assigned Number’ field. If that combination of ‘called party’ and ‘calling party’ is not found in the ‘pending call database’ the anonymous call server sets the dummy number to the first entry encountered in the ‘temporary pool’ (of dummy numbers) which does not appear in the ‘pending call database’ for that subscriber and inserts an entry into the ‘pending call database’ for that called party/calling party/dummy number (Assigned number) combination.
5. The system then generates an ‘anonymous call notification’ message with the following contents:
   The ‘identity’ of the caller is depicted as ‘anonymous’.
   The allocated dummy phone number is shown in the message as the number to be called to contact this caller.
   The notification thus could look like:
      “You received a call from an anonymous caller at 07:05 on Jul. 13, 2009. To change the settings for handling this call, please return a text message with the appropriate command.”
6. The called party replies with a text message with a command keyword as in Scenario 3, changing the settings for how this anonymous number should be handled in the future.

Scenario 5 (Refer to FIG. 7 for Details on ACS Internal Tables Interaction).

As mentioned in the previous scenario the system provides the capability for the called party to send a text message with a command keyword (request return call allowed) in this scenario back to the anonymous call server. Thus, after step 5 in scenario 4, the following steps are carried out:
1. The called party replies with a text message with the appropriate command keyword requesting that a request be made to the calling party that the called party be allowed to return a call to the calling party. (Such a request can be made by the called party via a self management interface such as a Web GUI).
2. The handset will send a reply SMS to the SMSC using an MO-FSM operation with the SMS B-party set to the dummy number supplied in the ‘missed call’ notification message.
3. The SMSC accepts the MO-FSM operation and sends it always to the anonymous call server using a normal Large Account connection for each number in the number pool that is assigned to the anonymous call server (alternatively the Large Account connection can service a range of such numbers).
4. The anonymous call server first looks up the ‘subscriber settings table’ for the combination where the SMS A-party is the ‘called party’ and the SMS B-party is the ‘Permanent Presentation No’. If that combination exists, the address to forward the request to is the ‘Caller Id’ i.e. the calling party in that record. Such a request is requesting consent for permanent ‘return call allowed’ from the calling party, i.e. that the called party can call the calling party at any time, not just based on returning a call attempt from the calling party.
5. If that combination does not exist in the subscriber settings table, the anonymous call server looks up the ‘pending call database’ for the combination where the SMS A-party is the ‘called party’ and the SMS B-party is the ‘Assigned Number’. The address to forward the request to then is the ‘calling party’ in that record. Such a request is requesting consent for temporary ‘return call allowed’ from the calling party, i.e. that the called party can call the calling party at any time, not just based on returning a call attempt from the calling party, as the Return Call Allowed will expire according to the Expiration time, which is not the case in the subscriber settings table which can be viewed as permanent as it does not have an expiry time explicitly defined.
6. The system generates a request SMS message sending it to a normal service centre using the SMPP or UCP interface to the original called party on behalf of the calling party requesting authorization to allow return calls from the called party and making it clear whether this is a time bound request and including the expiry time or whether this is a permanent request.
7. The normal service centre delivers the text message to the original caller.
8. If the calling party replies in this embodiment with an affirmative SMS, the Return Call allowed field is set in the appropriate table (subscriber settings table, or pending call database).
9. The called party is informed via SMS by the ACS that their request is successfully completed.
10. The called party can then at any time initiate a call to the calling party.
   Note: in the case where successful permanent ‘return call allowed’ has happened, the called party is likely to request the ACS to assign a Code Name to the Permanent Presentation number (which the subscriber can specify for example via a command SMS or a self care Web GUI) to, and once that has happened the Code Name can be stored in the called parties address book.

Scenario 6 (Refer to FIG. 7 for Details on ACS Internal Tables Interaction).

As mentioned in the previous scenario the system provides the capability for the called party to request that a Permanent Presentation number be assigned.

When a called party first receives a call from an anonymous calling party, as already described the system assigns a dummy number which has an expiry time and is stored in the Pending call table. If a called party for example receives several calls from a particular calling party and optionally chooses to subscribe to a service whereby the operator allows the subscriber define that the number presented to the subscriber for that calling party should always be the same, then a subscriber can request that a Permanent Presentation number be associated with a calling party.

In this scenario the request is via an SMS keyword (In alternative embodiments such a request can be made by the called party via a self management interface such as a Web GUI or an IVR interface). Thus after step 5 in scenario 4, the following steps are carried out:
1. The called party replies with a text message with the appropriate command keyword for example Request ‘Permanent Presentation number’ requesting that the anonymous call server associate a Permanent Presentation number with the calling party.
2. The handset sends a reply SMS to the SMSC using an MO-FSM operation with the SMS B-party set to the dummy number supplied in the ‘missed call’ notification message.
3. The SMSC accepts the MO-FSM operation and sends it always to the anonymous call server using a normal Large Account connection for each number in the number pool that is assigned to the anonymous call server (alternatively the Large Account connection can service a range of such numbers).
4. In this embodiment (refer to FIG. 7) there are two pools of numbers being shown, a Permanent Pool (a reserved pool of permanent numbers for the anonymous called server) and a Dummy Pool (a reserved pool of dummy numbers for the anonymous called server). Thus, in this embodiment the number used for the Permanent Presentation number is taken from the permanent pool. In assigning a Permanent Pool number, the system chooses the first entry it encounters in the Permanent Pool which does not appear in the Subscriber Settings table, simply checking the entry against numbers which have already been assigned for a particular ‘Calling Party’ subscriber in the Subscriber settings table. Since the ‘Permanent Presentation No’ is not set, (i.e. the ACS cannot use the dummy Calling Party number as a key to retrieve the real Calling party number from the Subscriber Settings table), the anonymous call server looks up its ‘pending call database’ for the combination where the SMS A-party is the ‘called party’ and the SMS B-party is the ‘Assigned Number’ i.e. dummy calling party number, and retrieves the real ‘calling party’ (Caller Identity) number. The anonymous call server updates the record for that called party and calling party (Caller ID) combination with the Permanent Presentation number in the Subscriber Settings table.
5. The anonymous call server sends an SMS to the called party, (sending it via a normal service centre using the SMPP or UCP interface) to the called party specifying the Permanent Presentation number that has been assigned.
6. The called party can then store the Permanent Presentation number in their address book.

As an optimization, additionally the called party is likely to request the ACS to assign a Code Name to the Permanent Presentation number (which the subscriber can specify for example via a command SMS or a self care Web GUI), and once that has happened the Code Name can be stored in the Called Parties address book.

Once a Permanent Presentation number exists in the Subscriber Settings Table, a subsequent call with that called party/CallerIdentity combination results in a new entry (or update of an existing entry) in the pending call database using the Permanent Presentation number as the assigned number in the pending call database.

The numbers in both the Permanent Pool and the Dummy Pool are all available for each subscriber. Thus, a subscriber's limit is simply the number of numbers in the Pools.

In an alternative embodiment there could be one pool for subscribers which is used for Assigned numbers for the Pending Call Database and for Permanent Presentation numbers. In this case when a subscriber chooses to define a Permanent Presentation number, the assigned number if it exists in the Pending Call Table can simply be migrated to the Subscriber Settings Table or alternatively the next available number in the pool is chosen.

The numbers in the pools (or pool), although all available for each subscriber, are a finite resource and a subscriber could exhaust such a resource. The action taken in such a case is dictated by operator policy.

The system of the invention enables additional functionality like web-based and IVR based administration interfaces for managing the screening lists (and subscriber settings), for example only allowing call back during a specific period. In addition, the command keywords in the system can be used to also for example allow diverting of the call: divert the anonymous call to a specific other telephone number if anonymous or if it is this specific anonymous number. In practice, this would be used for example by busy managers with their own secretary in which: any anonymous call is diverted to their secretary, or specific anonymous calls are diverted to their secretary after having been answered once by the manager.

Furthermore, the function can use other messaging technologies than SMS to notify/inform the called party of the anonymous call (e.g., e-mail, SIP messaging, MMS, outdial) and also can generate a daily or weekly digest (which can for example be delivered via an aggregated notification) together with the actions performed by the called party to provide a daily/weekly anonymous call overview, which could include information such as overview of pending calls, overview of registered permanent allocations with their additional settings etc. Although the embodiments show push notifications, the invention works advantageously in a pull context also, thus a subscriber can request information about one or more unknown caller(s) (e.g. dummy number, when called, associated overview of pending calls, associated overview of registered permanent allocations with their additional settings etc) on demand using a Pull Interface, where a command is sent and as a result an SMS for example (or other means e.g., e-mail, SIP messaging, MMS, outdial) is sent including information about a Missed call/Anonymous call (which can also have been answered or not).

Finally, if the pool of numbers reserved is sufficiently large that aging is not needed to make room for additional calls (e.g., a thousand numbers are reserved for the anonymous call server), it is also possible to for example to assign a ‘presentation number’ and a ‘code name’ to a specific anonymous party. In that case, the system is able to re-write the A-party address of the call always to that presentation number so that the A-party can be recognized specifically on the handset. In addition, the code name/code number is used in the SMS message/e-mail message sent for the anonymous call and/or the daily/weekly digest about anonymous calls and for maintenance of the subscriber settings including the assigned presentation numbers (e.g., a subscriber can list the code names and their assigned numbers, and then act on them for example by changing the settings or removing a specific assignment).

A single pool of numbers can be used for both assigned presentation numbers and dummy assigned numbers, or a separate pool for each. A separate pool for each has the advantage that dummy assigned numbers will always be available. A combined pool may be more efficient in the amount of numbers that may need to be allocated to the anonymous call server.

For legal reasons in specific countries, it may be necessary to extend the ‘anonymous missed call notification’ with an IVR message requesting approval for allowing the call back functionality. In this case, an IVR module is attached to the system generating a prompt that the call cannot be completed and that the calling party can select whether he wishes his anonymous call to be returned or not. If the answer is negative, it is logged that the calling party does not allow dial back or message return. In that case, the SMS is sent out as in Scenario 4 so that the called party is limited in his choices how to handle the call and cannot return the call.

The pool of numbers is shared across all subscribers, and that the combination of ‘called party’ and assigned number from the pool is what makes a record in the database unique. A beneficial side effect of this approach is that even if someone notices the SMS on your handset, the assigned number from the pool is of no value to that person as it would refer to his local anonymous calls which might be not present or a totally different party.

Referring to FIGS. 4 and 5 operation of a system of the invention is shown. The cloud in the diagrams indicates that the A party may reside inside the same network as the B party or in another network. Signalling towards the MSC contains the A party address in addition to the B party address and a CLIR indicator. In an alternative embodiment (FIG. 5), the service is mapped onto an EMS network in which case the S-CSCF replaces the MSC and the anonymous call server is located as an AS on top of the S-CSCF on the ISC reference point.

The MSC is responsible for routing the call information to the anonymous call server through either ISUP or INAP, the S-CSCF using SEP on the ISC reference point.

The anonymous call server then accepts the call information and based on the call information and its database executes specific actions. The anonymous call server internal structure is shown in FIG. 6.

The internal components in the anonymous call server are responsible for the following functions:
Signalling Interface: interface to the MSC or the CSCF using a specific protocol. Regardless of which interface is used, in the end it is normalized to call routing information in a normalized internal format and sent to the call router component.
Call router component: the call router component performs a lookup on the A- and B-party addresses.
   If the A-party has CLIR set and the B-party is registered in the subscriber database, and there are rules in the subscriber database for this A-party, the call router will execute these rules in the signalling system (e.g., block call or divert call to voice mail system, or forward to incoming anonymous call handler).
   If there are no rules, but the B-party is registered, the call routing information is passed to the Incoming Anonymous Call handler.
   If the B-party number is a number allocated to the anonymous call server and the A-party is a subscriber of the anonymous call server, the information is passed to the Return call handler.
Incoming Anonymous Call Handler. In the case a new anonymous call comes in, or the settings of the B-party indicate that these calls always have to be handled in the same manner, the Incoming Anonymous Call handler is activated. This call handler will store the CLIR information of this A-party in the database and assign a dummy number out of the available pool for the Anonymous Call handler to the entry. Then, a request is sent to the SMS interface to send out a message containing the anonymous call notification information. In the case of SMS, the service center address or the A-party address can be set to the specific assigned dummy number, so that a reply to this interface will be delivered to the anonymous call server.
Return Call Handler. If a request for call set up comes in requesting the setting up of a call from a anonymous call server subscriber to one of the numbers from the pool assigned to the anonymous call server, the Return Call Handler will query the Pending call database for this combination. If the combination is found, the B-party address is replaced with the address of the original Anonymous party whose call is being returned and the call is set up through the network. If this address is no longer available, the appropriate error information is returned to the subscriber, either through signalling (number does not exist) or through an IVR prompt.
Subscriber Settings: this table contains the following fields:
   Called Party: the subscribers of the anonymous call server (this is the primary key linking a record in the Subscriber Setting Table and the Pending call table/
   Caller ID: This field contains the calling party ID. It is mandatory to specify it where there are specific Actions or settings such as Permanent Presentation number or Return Call allowed associated with a specific calling party and called party combination. The called party also has the option of specifying a single default action for all calls or all anonymous calls and can indicate this by configuring ‘*’ (wild card, indicating any Calling Party)) and defining the appropriate action, e.g. Divert Anonymous (i.e. divert all anonymous calls).
   Action(Keyword): optionally specific settings which can be defined by a called party such as rules for a specific calling party on how to handle new incoming calls (e.g., always block and notify, always divert to voicemail and notify, notify only on missed calls et cetera).
   Action (Ancillary Info): optionally defines extra information associated with an Action. For example, a voicemail system number or secretary number to whom the call should be diverted.
   Permanent Presentation Number: when a called party first receives a call from an anonymous calling party, as already described the system assigns a number which has an expiry time and is stored in the Pending call table. If a called party for example receives several calls from a particular calling party and optionally chooses to subscribe to a service whereby the operator allows the subscriber define that the number presented to the subscriber for that calling party should always be the same, then a subscriber can request that a Permanent Presentation number be associated with a calling party.
   In the embodiment shown there are two pools of numbers being shown, a Permanent Pool (a reserved pool of permanent numbers for the anonymous called server) and a Dummy Pool (a reserved pool of dummy numbers for the anonymous called server). In this embodiment the number used for the Permanent Presentation number is taken from the permanent pool. Numbers in both the Permanent Pool and the Dummy Pool are all available for each subscriber. Thus, a subscriber's limit is simply the number of numbers in the Pools. In assigning a Permanent Pool number, the system chooses the first entry it encounters in the Permanent Pool which does not appear in the Subscriber Settings table, simply checking the entry against numbers which have already been assigned for a particular subscriber in the Subscriber settings table.
   Once a Permanent Presentation number exists in the Subscriber Settings Table, a subsequent call with that Called Party/CallerIdentity combination results in a new entry (or update of an existing entry) in the pending call database using the Permanent Presentation number as the assigned number in the pending call database.
   In an alternative embodiment there could be one pool for subscribers which pool is used for Assigned numbers for the Pending Call Database and for Permanent Presentation numbers. In this case when a subscriber chooses to define a Permanent Presentation number, the assigned number if it exists in the Pending Call Table can simply be migrated to the Subscriber Settings Table or alternatively the next available number in the pool is chosen.
   The numbers in the pools (or pool) although all available for each subscriber are a finite resource and a subscriber could exhaust such a resource. The action taken in such a case is dictated by operator policy.
   Code Name: Optionally, the called party can define Name strings against permanent presentation numbers. In the case where the Return Call Allowed is set to the affirmative, the Caller Identity could be the real name of the original calling party,
   Return Call Allowed: A called party can request via a self management interface (such as a Web GUI) or an SMS command (which could be a reply to an ‘anonymous call notification’ message that a request be made to the calling party that the called party be allowed to return a call to the calling party. On such request an SMS could be sent to the calling party requesting authorization to do this. If the calling party replies in this embodiment with an affirmative SMS, the Return Call allowed field is set appropriately and the called party is informed via SMS that their request is successfully completed. The called party can then at any time initiate a call to the calling party. Note the distinction from the Return Call Allowed field in the Pending call database in that there the Return Call Allowed will expire according to the Expiration time, whereas the Return Call Allowed field in the Subscriber settings table can be viewed as permanent as it does not have an expiry time explicitly defined.
   Last Used: This field is intended to allow the subscriber manage what is a finite resource, i.e. available pool numbers. Thus, the system can notify a subscriber if a certain number has not been used in a certain period, prompting the subscriber to perhaps allow that Permanent Presentation number back into the pool, or the subscriber can see from for example a web management interface the last time that Permanent Presentation number was used.
   The subscriber settings table is updated by the command handler which can be accessed via multiple access channels, e.g. the messaging interface or via a Web GUI etc.
Pending call database. This database contains the pending calls consisting of a combination of called party, the caller id of the party that made an anonymous call to the subscriber (i.e. calling party), the assigned (dummy) number from the pool and a timestamp indicating the expiration time of the entry in the Pending Call database.
   Assigned Number: when a called party first receives a call from an anonymous calling party, as already described the system assigns a dummy number which has an expiry time and is stored in the Pending Call table.
   In the embodiment shown there are two pools of numbers being shown, a Permanent Pool (a reserved pool of permanent dummy numbers for the anonymous called server) and a Temporary Pool (a reserved pool of temporary dummy numbers for the anonymous called server).
   In this embodiment the dummy number used for the Assigned number in the pending call database is taken from the Temporary Pool.
   As described further in description for “Permanent Presentation number”, if a specific entry already exists in the Subscriber Settings table then that “Permanent Presentation number” is used as the “Assigned number” in the Pending Call Database”, otherwise the first entry encountered in the Temporary Pool which does not appear in the Pending Call database for that subscriber is used.
   The numbers in both the Permanent Pool and the Temporary Pool are all available for each subscriber. Thus, a subscriber's limit is simply the number of numbers in the Pools. The numbers in the pools (or pool) although all available for each subscriber are a finite resource and a subscriber could exhaust such a resource. The action taken in such a case is dictated by operator policy.
   Return Call Allowed: A called party can request via a self-management interface (such as a Web GUI) or an SMS command (which could be a reply to an ‘anonymous call notification’ message that a request be made to the calling party that the called party be allowed to return a call to the Calling Party. On such a request an SMS could be sent to the calling party requesting authorization to do this. If the calling party replies in this embodiment with an affirmative SMS, the Return Call allowed field is set appropriately and the called party is informed via SMS that their request is successfully completed. The called party can then initiate a call to the calling party. Note the distinction from the Return Call Allowed field in the Subscriber settings table which can be viewed as permanent as it does not have an expiry time explicitly defined, whereas in the Pending call database the Return Call Allowed setting will expire according to the Expiration time.
Pending call aging. This component autonomously ages entries in the pending call database that have exceeded the configured validity period.
Command Handler. This component interprets commands returned in messages or forwards the messages if they do not contain a command. In the case of a text message, the combination of the A-party address (i.e., the subscriber to the anonymous call server) and the B-party address (an address allocated from the anonymous call server pool) are used to identify the record in the Pending Calls database that identifies a specific anonymous party that made an earlier call the subscriber of the anonymous call server.
   If the message contains a command keyword, the command is executed. This command could be for example to always block this anonymous caller or always divert this anonymous caller (resulting in a settings update in the subscriber database), to purge this call (resulting in an update of the Pending call database) or to purge all pending calls (resulting in an update of the Pending call database).
   It also is possible that the message does not contain a command and then is sent out again to the messaging service applicable but now with the original anonymous caller as the B-party address.
Messaging Interface. The Messaging Interface has the responsibility to send out the SMS (or other type of messaging) notifications to the called party about the anonymous call. In addition, the Messaging Interface receives the reply messages of the called party on the anonymous call, which are either interpreted as a command, or forwarded to the anonymous calling party if it does not contain a command code. The Messaging Interface is aware of the multiple addresses in the pool and uses the address used in the pool together with the ‘A-party’ address (the original called party) to determine which anonymous call this message applies to.
Web interface. The Web interface provides the ability to directly operate on the subscriber settings database (to subscribe, unsubscribe or manage specific settings) and on the pending calls database (to purge a specific pending call or all pending calls).

It will be appreciated that in the invention the anonymous call server performs operations as a recipient network function, based on the real originator address together with an address hiding indicator ensuring that the recipient can perform functions on the received anonymous calls. Importantly, this allows the invention to provide functionality such as black listing or white listing specific anonymous callers.

The invention is not limited to the embodiments described but may be varied in construction and detail. For example the server could be used to provide details of anonymous caller numbers under special conditions. Such conditions may be governed by legal intercept conditions.

In an alternative embodiment, the functionality of scenario 3 can be provided using an IVR interface combined with an out-dial notification. The original SMS to the called party is then an outdial call instead. When the called party accepts the outdial notification, he enters an IVR interface that can be used to indicate the appropriate action keywords and associated information. In another embodiment, the functionality can be implemented as a WAP push notification containing an URI in which the dummy number is encoded. When the user browses to the URI, he directly is able to administer the actions for this anonymous calling party, assign code name and presentation number or send a message to the calling party through the ACS.

The embodiments include when the called party does a return call, the call coming to the anonymous call server (ACS) where the ACS does a look up, and initiates IAM to real number of the calling party, with the ACS itself completely doing such actions as handling dummy to real party mapping and IAM initiation. In an alternative embodiment the ACS could drive this call routing functionality through a HLR, with the ACS setting the divert (MAP) dummy number to the real number in the HLR itself. In this way the call to the dummy number can be directly routed to the real number of the original calling party by the core network and the ACS does not need to get directly involved for that action. The ACS would need to manage this closely, thus while the ACS interaction with HLR embodiment might help in the return call routing, the ACS would have to manage itself for example cancelling such a divert after the expiration period, and other value add features of the invention such as those enabled by the subscriber settings such as for example permanent presentation number, rules, code name, return call allowed which would all still be managed by and maintained in the ACS.

1. A voice call processing system for a communications network, the system comprising at least one call server, wherein the system is adapted to perform an operation in response to a call from an anonymous calling party to a called party, said operation using the identity of the anonymous calling party without revealing said identity to the called party,
wherein the system is adapted to automatically generate a dummy number for the anonymous calling party and to use the dummy number to guarantee anonymity by including said dummy number in a notification message or an out-dial notification; and
wherein said notification is a missed call notification or an anonymous call notification to the called party, allowing the called party to instruct or perform an operation in response to the anonymous call while guaranteeing anonymity.

2. The voice call processing system as claimed in claim 1, wherein the system is adapted to perform said operations as a recipient network function.

3. The voice call processing system as claimed in claim 1, wherein the system is adapted to allow the called party to return a call or to send a message to the anonymous calling party.

4. The voice call processing system as claimed in claim 1, wherein the system is adapted to perform a task in response to future calls or messages from the anonymous calling party, including filtering, blocking, or diverting said future call or message.

5. The voice call processing system as claimed in claim 1, wherein the system is adapted to request authorization for the calling party to call the called party on demand.

6. (canceled)

7. (canceled)

8. The voice call processing system as claimed in claim 1, wherein the system is adapted to maintain in a table an association between the dummy number and an actual phone number of the calling party.

9. The voice call processing system as claimed in claim 1, wherein the system is adapted to send a notification message to the anonymous calling party as part of an operation.

10. The voice call processing system as claimed in claim 1, wherein the system is adapted to manage call screening of anonymous calls for subscribers, wherein said call screening includes diverting future calls from an anonymous calling party and/or generating anonymous call reports for the called party; and wherein the system is adapted to receive from a subscriber a request for an operation wherein the system is adapted to receive from a subscriber a request for an anonymous call screening operation; and wherein the system is adapted to receive and parse a request in the form of a message with a keyword command such as ‘block always’, ‘block anonymous’, ‘divert always’ or ‘divert anonymous’.

11. (canceled)

12. (canceled)

13. (canceled)

14. (canceled)

15. (canceled)

16. The voice call processing system as claimed in claim 1, wherein the system is adapted to generate a notification message for the called party whenever an anonymous party has called, irrespective of whether the call has been missed.

17. The voice call processing system as claimed in claim 1, wherein the system is adapted to apply at least one condition on an option for the called party to return the call; and wherein a condition is a time limit; and, wherein a condition is a limit on the number of return calls allowed; and wherein the system is adapted to update a database according to operations performed, including deleting a database record if an option to perform an operation has terminated.

18. (canceled)

19. (canceled)

20. (canceled)

21. The voice call processing system as claimed in claim 1, wherein the system is adapted to process notification messages in any of a range of protocols including SMS, SIP messaging, and MMS.

22. The voice call processing system as claimed in claim 1, wherein the system comprises an interactive voice response system adapted to generate a message requesting approval for an operation.

23. The voice call processing system as claimed in claim 1, wherein the system comprises an interactive voice response system adapted to generate a message requesting approval for an operation; and wherein the interactive voice response system is adapted to generate a prompt that a call cannot be completed and that the calling party can select whether he wishes his anonymous call to be returned or not, and if the answer is negative, it is logged that the calling party does not allow dial back or message return.

24. The voice call processing system as claimed in claim 1, wherein a combination of called party number and a dummy number form at least part of a unique reference for a database record.

25. The voice call processing system as claimed in claim 1, wherein the system is adapted to terminate use of a dummy number, such as by deleting it from a database, wherein the system is adapted to perform said deletion in response to a condition; and wherein a condition is return of a particular number of calls to the anonymous caller; and
wherein a condition is expiry of an ageing period.

26. (canceled)

27. (canceled)

28. (canceled)

29. The voice call processing system as claimed in claim 1, wherein the system is adapted to pro-actively request permission from the called party before performing an operation which it proposes.

30. The voice call processing system as claimed in claim 1, wherein the system is adapted to provide information to the called party in response to a pull request, instead of or in addition to providing such information in a notification.

31. A method of operation of a voice processing system in a communication network, the method comprising the system performing an operation in response to a call from an anonymous calling party to a called party in a recipient network associated with the system, said operation using the identity of the anonymous calling party without revealing said identity to the called party.

32. The method as claimed in claim 31, comprising the step of allowing the called party to return a call or to send a message to the anonymous calling party.

33. The method as claimed in claim 31, comprising performing a task in response to future calls or messages from the anonymous calling party, said tack being filtering, and/or blocking, and/or diverting said future call or message.

34. The method as claimed in claim 31, wherein the system requests authorization for the calling party to call the called party on demand.

35. The method as claimed in claim 31, wherein the system automatically generates a dummy number for the anonymous calling party and uses the dummy number to guarantee anonymity by including said dummy number in a notification message or an out-dial notification.

36. The method as claimed in claim 31, wherein the system automatically generates a dummy number for the anonymous calling party and uses the dummy number to guarantee anonymity by including said dummy number in a notification message or an out-dial notification; and wherein said notification is a missed call notification or an anonymous call notification to the called party, allowing the called party to instruct or perform an operation in response to the anonymous call while guaranteeing anonymity.

37. The method as claimed in claim 31, wherein the system sends a notification message to the anonymous calling party as part of an operation.

38. The method as claimed in claim 31, wherein the system manages call screening of anonymous calls for subscribers, including diverting future calls from an anonymous calling party and/or generating anonymous call reports for the called party.

39. The method as claimed in claim 31, wherein the system receives from a subscriber a request for an anonymous call screening operation; and wherein the request is in the form of a message with a keyword command such as ‘block always’, ‘block anonymous’, ‘divert always’ or ‘divert anonymous’.

40. (canceled)

41. The method as claimed in claim 31, wherein the system provides to a called party, under conditions, the actual number of an anonymous calling party from internal records.

42. The method as claimed in claim 31, wherein the system generates a notification message for the called party whenever an anonymous party has called, irrespective of whether the call has been missed.

43. The method as claimed in claim 31, wherein the system applies at least one condition on an option for the called party to return the call, said condition being a time limit, and/or a limit on the number of return calls allowed.

44. The method as claimed in claim 31, wherein the system pro-actively requests permission from the called party before performing an operation which it proposes.

45. A computer program product comprising a computer readable medium having a computer readable program code adapted to be executed to implement a method of claim 31.
